(19) United States
(12) Patent Application Publication
(10) Pub. No.: US 2001/0024489 A1
(43) Pub. Date: Sep. 27, 2001

(54) Testing of telecommunication facilities

(76) Inventor: Torsten Jäkel, Berlin (DE)

Correspondence Address: Francis I. Gray, TEKTRONIX, INC., MS 50-LAW, P.O. Box 500, Beaverton, OR, 97077, US

(21) Appl. No.: 09/795,405

(22) Filed: Feb. 27, 2001

(30) Foreign Application Priority Data
Mar. 24, 2000 (EP) 00106442.7

(51) Int. Cl. H04M 1/24; H04M 3/08

(52) U.S. Cl. 379/15.01; 379/27.01

(57) ABSTRACT

A method of testing telecommunication facilities first records a real communication between at least two telecommunication facilities. The recorded real communication is then analyzed, and from the results of the analysis a test case is generated. The test case is then used to test one of the telecommunication facilities and the test results are evaluated. The method may be incorporated as part of a test generator.

### BACKGROUND OF THE INVENTION

The present invention relates to telecommunication test and measurement, and more particularly to a method of testing telecommunication facilities and to a test generator using the method.

Telecommunication facilities include not only telecommunication equipment, such as switches and data terminal equipment, but also interacting individual systems within a piece of telecommunication equipment, with the term “individual system” including both hardware and software. Telecommunication technology is a rapidly growing area. With both hardware and software the versions change in quick succession. Naturally, every telecommunication facility is connected to other telecommunication facilities. If there is to be a change in hardware or software versions or in another manufacturer's product, one tries on the one hand, in order to prevent outage of the telecommunication facility and possibly of the network in which the telecommunication facility is incorporated, to ensure before such change that the earlier version and the new version may actually be exchanged. On the other hand the aim is to determine what possibilities the new component offers and/or what messages and/or message components, hereinafter referred to as “messages”, are no longer “understood” by the new component and therefore have to be replaced or changed, the focus being on checking the data exchange between the telecommunication facilities linked.

When checking the data exchange one has to examine whether the messages exchanged feature all necessary components and parameters, whether the sequence of the message parameters is correct, and whether the sequence of messages is correct.

In the prior art, as shown in FIG. 1, a user generates a test case manually, i.e., the user programs the test case knowing the protocol on the basis of which the communication between the telecommunication facility to be tested (System Under Test—SUT) and the telecommunication facilities connected thereto is to take place. The test case is entered into a tester, the tester is connected to the SUT, and the test case, i.e., the communication procedure programmed by the user, is carried out as indicated by the arrows. The disadvantage of this approach is that it requires much effort to generate a test case with which the most diverse communications offered by a selected protocol may be checked. Test cases already prepared for testing other telecommunication facilities often cannot be used, as telecommunication facilities use proprietary protocols or protocol dialects from time to time which do not conform to standards.

What is desired is a method of generating test cases for telecommunication facilities that is easier for a user.

### BRIEF SUMMARY OF THE INVENTION

Accordingly the present invention provides a method of testing telecommunication facilities by recording a real communication between at least two telecommunication facilities, then analyzing the real communication, and finally generating a test case based on the results of the analysis. This is achieved by using a test generator having means for recording a real communication between at least two telecommunication facilities, means for analyzing the real communication, and means for generating the test case based on the results of the analysis.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a block diagram view of a prior art setup for testing a telecommunication facility.

FIG. 2 is a schematic diagram view representing an approach for testing telecommunication facilities according to the present invention.

FIG. 3 is a block diagram view representing steps illustrating one embodiment of the method of testing telecommunication facilities according to the present invention.

FIG. 4 is a pictorial view representing the principle of sequence formation according to the present invention.

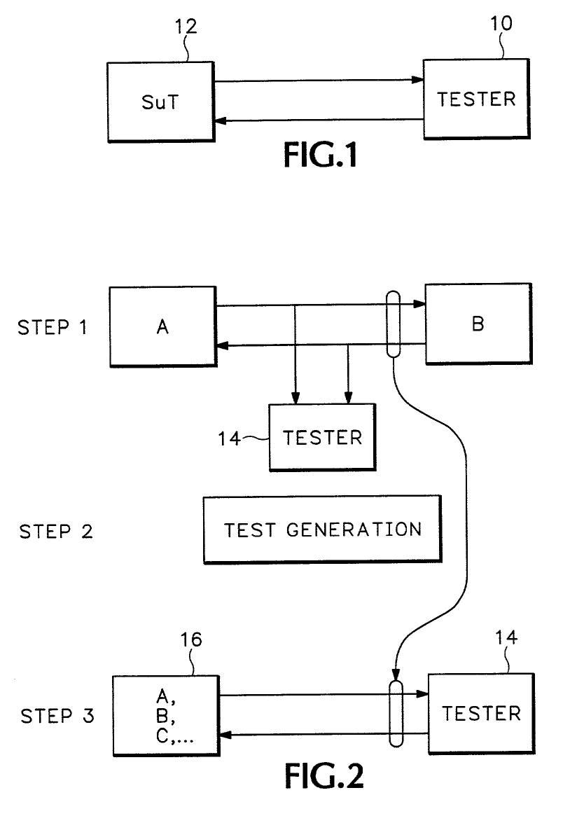

### DETAILED DESCRIPTION OF THE PRESENT INVENTION

When an exchange of messages between two telecommunication facilities is recorded over an extended period of time, there is a repetition of some procedures, such as during connection build-up and connection cleardown. Because of these repetitions it is possible to recognize recurring procedures, to determine variable elements of the messages exchanged, and to identify secondary conditions or pre-conditions of partial sequences. With the real communication as a reference it is possible to use such an analysis to establish sending and receiving relationships that are comparable to message sequence charts. Moreover it is determined when and how the tester reacts and/or how the tester may actively simulate. Thus the communication recorded serves as a reference for the repetition of test cases under the same or under changed conditions.

For a user this results in very little effort when generating the test case. A direct comparison is made between telecommunication facilities manufactured by different vendors, with performance and repeatability under real conditions and under changed secondary conditions, a swift repeatability and adaptability as well as an understanding of the real procedures that take place under specific test conditions in order to understand errors resulting from active operation in laboratory tests. This results in considerable time savings as well as in the reproducibility and comparability of regression tests. In an ideal manner the generation of a test case is followed by the performance of the actual test itself and then by the evaluation of the test. The advantage is an automatic independent performance of the test and an automatic evaluation of the test results .

Such facilities may also be provided in a test generator. However the results of the test performed may be transferred by the test generator to a separate evaluation unit. The analysis of the real communication may include the following partial steps: atomization of procedures, formation of sequences, determination of stimuli-response and/or reaction relations, and identification of variable elements in the stimuli and responses. When the test case is generated the following partial steps may occur: generation of stimuli, derivation of target responses and/or target reactions, compilation of test scenarios and parameterization of tests. When the test case is performed the following partial steps, among others, may occur: excitation of a telecommunication facility with generated stimuli, recordation of responses, reaction to messages and recordation of time behavior. With the evaluation of the test the following partial steps are relevant: analysis of the responses recorded, comparison of responses recorded, target responses and/or target reactions, recognition and variation of variable elements and identification of deviatioins in the procedure and deviations in the contents of the messages.

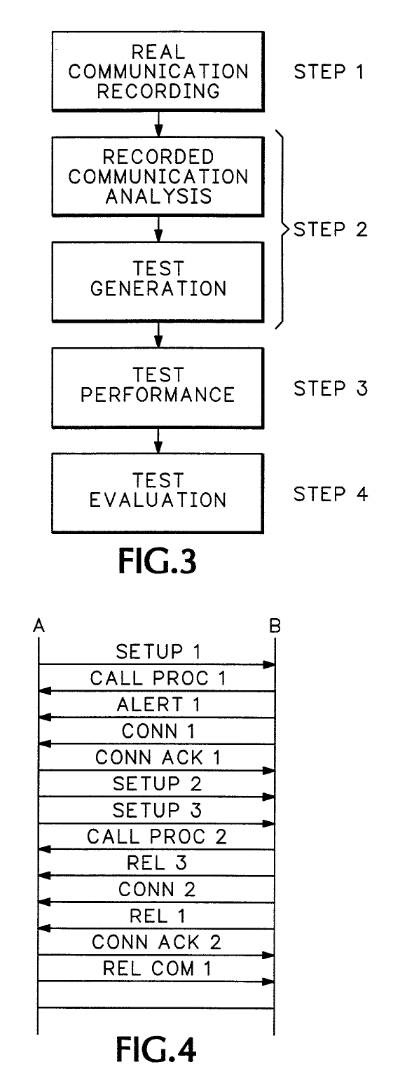

Referring now to FIG. 2 a schematic representation of the telecommunication facility testing method is shown. The steps entered in FIG. 2 correlate with the steps entered in FIG. 3. In Step 1 real communication traffic occurring between subscribers A and B is first of all recorded by a tester or test generator 14. In Step 2 the real communication traffic, i.e., the complex communication procedure, is broken down into atomic sequences and relations in order to generate the test case. The analysis may use the methods described in U.S. patent application Ser. No. 09/068,878 filed Feb. 22, 2000 entitled “Method for Checking a Data Exchange Based on a Communication Protocol”, the contents of which are incorporated herein by reference. The analysis involves the use of a target description of a state machine to analyze the communication sequence, i.e., the course of the protocol.

Alternatively the analysis may take place on the basis of similarity analyses of the messages, i.e., of the components of the real communication in respect to each other. Here it is the particular message content that is of significance. During the evaluation of the messages and the formation of the atomic sequences, the contents of the messages, such as routing labels, are used to detect the togetherness of message sequences. In this process routing labels serve to find out who communicates with whom in a network, i.e., they serve the purpose of making it possible for the individual messages to be allocated to a specific telecommunication facility. This may require the use of a decoder. It is particularly advantageous if the tester 14 knows the protocol, i.e., the protocol description, to be analyzed, especially the configuration of the messages and the meaning of the individual elements of a message. As part of the communication analysis one or several of the following partial steps are carried out: atomization of procedures, formation of sequences, determination of stimuli-response and/or reaction relations, and identification of variable elements in the stimuli and responses.

If during the analysis variable elements are detected in a response, they are given special treatment during the comparison, which means that they are excluded from a check for correct matching (wild card), though it is possible to check the semantics, and they may be checked for the same format. In the case of variable elements the user has the following options from which to choose: occupy the variable elements of the stimuli and responses with arbitrary data, occupy the variable elements with values determined as part of the recordings, provide a specification prior to the application, or as is especially valuable for sequence numbers take them from previous messages.

Using the recorded communication it is also possible to determine invariant response relations. For example, it is possible to determine from the course of the communication whether a message may arrive at any point in time, i.e., before or after another message, and which response time behavior applies to the comparison following later. Minimum and maximum dead times for recognition may also be defined.

FIG. 4 clearly shows an example of a real communication procedure between two telecommunication facilities A and B. Individual messages may be combined as groups:

a) First B is stimulated by A (SETUP 1) and B responds in accordance wtih the protocol with CALL PROC 1.

b) Using an ALERT 1 message B sends a spontaneous response to A.

c) In another example B sends a CONN 1 connection enquiry to A. A responds by acknowledging the connection enquiry with CONN ACK1.

d) Next A stimulates telecommunication facility B with SETUP 2 or SETUP 3. B responds to SETUP 2 with CALL PROC 2, while responding to SETUP 3 with REL 3.

e) Next B sends a connection enquiry (CONN 2) to A and a message REL1 also to A. A responds to CONN 2 with CONN ACK2 and to REL1 with REL COM1.

During generation of the test case in Step 2 one or several of the following partial steps continue to be performed: generation of stimuli, derivation of target responses and/or target reactions, compilation of test scenarios, and parameterization of tests.

During subsequent performances of the test in Step 3 the tester 14 acts as one of the participants in the communication. Its counterpart 16 may be one of the telecommunication facilities whose real communication is recorded in Step 1 (A or B), but it may also be another piece of equipment (C) or another version, etc. Apart from the tester 14 several other telecommunication participants may take part in the test. When the test is carried out, the tester responds on the one hand to incoming messages by sending the corresponding responses to system 16 which is to be tested. On the other hand the tester 14 sends the stimuli generated in Step 2 and the responses sent by SUT 16 are recorded. As part of this process one or more of the following partial steps may occur: excitation of a telecommunication facility to be tested with generated stimuli, recordation of responses; reaction to messages and recordatioin of time behavior.

During subsequent evaluation in Step 4 the responses are evaluated in terms of correctness with respect to the responses recognized and evaluated earlier during the recording of the real communication. This allows recognizing deviations in the protocol procedure and the components and elements of the responses received. When evaluating the tests, the following partial steps may occur: analysis of the responses recorded, comparison of responses recorded against target responses and/or target reactions, recognition and marking of variable elements, and identification of deviations in the procedure and in the contents of the messages.

If only part of the possibilities made available by the protocol is used within the real communication between telecommunication facilities A and B, application of the method results at least in the advantage that a test scenario only has to be programmed manually for the remaining possibilities of the protocol not used so far by A and B. Alternatively the test generated by tester 14 may be used as a basis that only has to be changed with respect to the possibilities of the protocol not used.

Thus the present invention provides telecommunication facility testing by recording real communications between at least two telecommunication facilities, analyzing the recorded real communications, and generating a test case based on the results of the analysis.

What is claimed is:

1. A method of testing telecommunication facilities comprising the steps of:
a) recording a real communication between at least two telecommunication facilities;
b) analyzing the recorded real communication; and
c) generating a test case based on the results of the analyzed recorded real communication.

2. The method as recited in claim 1 further comprising the step of:
d) performing the test case with at least one of the telecommunication facilities.

3. The method as recited in claim 2 further comprising the step of:
e) evaluating the results of the test case performance for the at least one of the telecommunication facilities.

4. The method as recited in claim 1 wherein the analyzing step comprises one or more of the following steps:
b1) atomizing protocol procedures;
b2) forming procedure sequences;
b3) determining stimuli-responses and/or reaction relations in the real communications;
b4) identifying variable elements in the stimuli and responses.

5. The method as recited in claim 1 wherein the generating step comprises one or more of the following steps:
c1) generating stimuli;
c2) deriving target responses and/or target reactions;
c3) compiling at least one test scenario;
c4) parameterizing at least one test.

6. The method as recited in claim 5 wherein the performing step comprises one or more of the following steps:
d1) exciting one of the telecommunication facilities to be tested with generated stimuli;
d2) recording responses to the generated stimuli of the telecommunication facility under test;
d3) reacting to messages received from the telecommunication facility under test;
d4) recording time behavior for the telecommunication facility under test.

7. The method as recited in claim 6 wherein the evaluating step comprises one or more of the following steps:
e1) analyzing the recorded responses;
e2) comparing the recorded responses against target responses and/or target reactions;
e3) recognizing and marking variable elements in the responses;
e4) identifying deviations in the protocol procedure and contents of the messages.

8. The method as recited in claim 1 wherein the generating step is performed by a test generator automatically and without interfering action by an operator.

9. A test generator comprising:
means for recording a real communication between at least two telecommunication facilities;
means for analyzing the recorded real communication; and
means for generating a test case based on the analysis of the recorded real communication by the analyzing means.
